(19) United States
(12) Patent Application Publication
(10) Pub. No.: US 2025/0317844 A1
(43) Pub. Date: Oct. 9, 2025

(54) METHOD AND APPARATUS FOR NETWORK ENERGY SAVING

(71) Applicant: Wistron NeWeb Corp., Hsinchu (TW)

(72) Inventor: Hung-Chen CHEN, Hsinchu (TW)

(21) Appl. No.: 19/096,830

(22) Filed: Apr. 1, 2025

Related U.S. Application Data
(60) Provisional application No. 63/573,555, filed on Apr. 3, 2024.

(51) Int. Cl. H04W 52/02; H04W 24/10; H04W 56/00; H04W 76/20; H04W 80/02

(52) U.S. Cl. CPC H04W 52/0203; H04W 24/10; H04W 56/0015; H04W 76/20; H04W 80/02

(57) ABSTRACT

A method for network energy saving is provided. The method is implemented by a user equipment (UE) and includes receiving a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration. The method includes performing an on-demand SSB-based SCell operation based on the one or more on-demand SSBs. The method includes receiving a second MAC CE, wherein the second MAC CE indicates that the on-demand SSB configuration of the first SCell is deactivated. The method includes stopping the on-demand SSB-based SCell operation.

### CROSS REFERENCE TO RELATED APPLICATIONS

This application claims the benefit of U.S. Provisional Application No. 63/573,555, entitled “Method and Apparatus for Network Energy Saving”, filed on Apr. 3, 2024, the entirety of which is incorporated by reference herein.

### TECHNICAL FIELD

The present disclosure generally relates to wireless communication. More specifically, aspects of the present disclosure relate to a method and an apparatus for network energy saving.

### BACKGROUND

Unless otherwise indicated herein, the approaches described in this section are not prior art to the claims listed below and are not admitted as prior art by inclusion in this section.

Network energy saving in 5G has received significant attention in recent years because of the increasing number of small cells and the use of massive multiple-input multiple-output (MIMO) antennas. It is undoubtedly important to reduce the environmental impact and to help operators save on their operating expenses. Therefore, there is a need to develop specified approaches for network energy saving in 5G. In 3GPP Release 18, for the sake of network energy saving, the techniques for SSB (Synchronization Signal Block)-less SCell (Secondary Cell) operations for inter-based CA (Carrier Aggregation) for FR1 and co-located cells has been introduced. That is, for an intra-band or inter-band CA SCell, a UE may obtain a timing reference and AGC (Automatic Gain Control) source from another serving cell in case the UE is not provided with SSB nor SMTC (SSB based Measurement Timing Configuration) configuration for this SCell, as described in TS 38.300 and TS 38.331 of Release 18. In addition, cell DTX/DRX (Discontinuous Transmission or Discontinuous Reception) mechanism has been specified to facilitate reducing gNB downlink transmission or uplink reception active time. Specifically, when cell DTX is configured and activated for a particular cell, the UE may not monitor PDCCH (Physical Downlink Control Channel) in selected cases or does not monitor SPS (Semi-Persistent Scheduling) occasions during cell DTX non-active duration of the particular cell. When cell DRX is configured and activated for a particular cell, the UE does not transmit CG (Configured Grant) resources or does not transmit a SR (Scheduling Request) during cell DRX non-active duration of the particular cell. This feature is only applicable to UEs in the RRC_CONNECTED state and it does not impact Random Access procedures, SSB transmission, paging, and system information broadcasting. Other solutions have been included in 3GPP Release 18 to further save NW power. One solution is that a NG-RAN node owning a coverage cell can request neighboring NG-RAN node(s) owning a capacity booster cell to switch on some SSB beams within the cell which are deactivated. Another solution is that an NG-RAN node can page certain UEs (e.g., stationary UEs) in RRC_INACTIVE state on a limited set of beams, instead of paging on all the beams within the cell. To avoid negative impacts on UE which does not support the feature(s) related to network energy saving, if a cell is activating or going to activate NES cell DTX/DRX, the cell can allow the access of UEs capable of NES cell DTX/DRX via a single bit in SIB1 but prevent the access of UEs not capable of cell DTX/DRX using barring mechanisms as introduced in TS 38.300 of Release 18.

Due to time limit, certain beneficial techniques for network energy saving have not yet been considered in 3GPP Release 18. There is an urgent need to introduce these beneficial techniques to fully complete the goals of network energy saving.

One of the lack techniques is to support on-demand SSB SCell operations for UEs (User Equipment) in RRC_CONNECTED state configured with CA, as stated in RP-234065. On-demand SSB is not always transmitted by a cell but only being transmitted when a UE needs to perform time/frequency synchronization to this SSB-less cell or to perform SCell activation operation for this SSB-less cell. Since on-demand SSB(s)/SSB Burst(s) is not always transmitted (or broadcast), power consumption of a base station of this cell can be reduced, especially when this cell does not need to serve any UE. However, the detailed procedures and signaling methods to support on-demand SSB SCell operation are not yet defined.

As such, how to design on-demand SSB SCell operations for network energy saving has become an important issue. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and an apparatus for network energy saving are provided in the present disclosure. The main purpose of the disclosure is to support on-demand SSB SCell operations for network energy saving, including designs for performing an on-demand SSB SCell operation for an SSB-less SCell, signaling for triggering an UE to perform an on-demand SSB SCell operation for an SSB-less SCell, UE capabilities of supporting an on-demand SSB SCell operation, and the corresponding UE behavior.

In an exemplary embodiment, a method for network energy saving is provided. The method is implemented by an user equipment (UE) and comprises receiving a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration. The method includes performing an on-demand SSB-based SCell operation based on the one or more on-demand SSBs. The method includes receiving a second MAC CE, wherein the second MAC CE indicates that the on-demand SSB configuration of the first SCell is deactivated. The method includes stopping the on-demand SSB-based SCell operation.

In an exemplary embodiment, an apparatus for network energy saving is provided. The apparatus comprises a transceiver and a processor. The transceiver which, during operation, wirelessly communicates with at least one network node. The processor communicatively coupled to the transceiver such that, during operation, the processor performs operations comprising receiving a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration. The processor performs operations comprising performing an on-demand SSB-based SCell operation based on the one or more on-demand SSBs. The processor performs operations comprising receiving a second MAC CE, wherein the second MAC CE indicates that the on-demand SSB configuration of the first SCell is deactivated. The processor performs operations comprising stopping the on-demand SSB-based SCell operation.

In an exemplary embodiment, a method for network energy saving is provided. The method is implemented by a source base station (BS) and comprises transmitting a first Medium Access Control (MAC) Control Element (CE) to a user equipment (UE), wherein the first MAC CE indicates that an on-demand synchronization signal block (SSB) configuration of a first secondary cell (SCell) is activated. The method further comprises transmitting a second MAC CE to the UE, wherein the second MAC CE indicates that the on-demand SSB configuration of the first SCell is deactivated.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 shows a signaling procedure for adding an SCell by sending an RRC Reconfiguration message with a first IE and a second IE from the NW to the UE according to an implementation of the present disclosure.

FIG. 2 shows an on-demand SSB SCell operation triggered by an on-demand SSB notification command according to an implementation of the present disclosure.

FIG. 3 shows the On-Demand SSB Notification MAC CE of one octet according to an implementation of the present disclosure.

FIG. 4 shows an UE capability reporting procedure according to an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides service to one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapping coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

It should be understood that the term “on-demand SSB SCell operation” may be interchangeably used throughout this disclosure with the term “on-demand SSB-based SCell operation”.

### Designs for On-Demand SSB SCell Operation

In one implementation, the UE may receive a DL signaling (e.g., an RRC signaling, a Medium Access Control (MAC) Control Element (CE), or a Downlink Control Information (DCI)) to perform an on-demand SSB SCell operation (e.g., by activating an on-demand SSB configuration) for a target SCell (e.g., an SSB-less SCell) and/or activate/deactivate the target SCell. In one implementation, the target SCell (e.g., an SSB-less SCell) on which the UE needs to perform the on-demand SSB SCell operation may be a candidate cell configured by the NW (Network) (e.g., in an SCell configuration) for the purpose of carrier aggregation (CA), and the state of the target SCell may be indicated as “activated” (e.g., when a specific IE (information element is present) or “deactivated” (when the specific IE is not present). For example, in a cell group configuration (e.g., CellGroupConfig), the NW may add or modify SCell(s) in a first list (e.g., sCellToAddModList) and/or may release SCell(s) in a second list (e.g., sCellToReleaseList). Each entry of the first list may be an SCell configuration including an SCell ID of an SCell (e.g., SCellIndex), a serving cell configuration of the SCell, and/or state of the SCell (e.g., activated or deactivated). The serving cell configuration of an SCell may include bandwidth part (BWP) related information (e.g., UL BWP configuration, DL BWP configuration, or a first active BWP, but it should not be limited in the disclosure), DL data or control channel related information, UL data or control channel related information and/or an SCell deactivation timer (e.g., sCellDeactivationTimer), but it should not be limited in the disclosure. Each entry of the second list may be an SCell ID of an SCell (e.g., SCellIndex) to indicate that an associated SCell is to be released.

In one implementation, the NW may configure the UE to add an SCell (e.g., an SSB-less SCell) by using a first list and an associated SCell configuration of the SCell may include a first IE to indicate the state of the SCell and a second IE to indicate whether an on-demand SSB SCell operation is required to be performed (e.g., to acquire on-demand SSB of an SSB-less cell for time or frequency synchronization to the SSB-less cell and/or to perform L1 or L3 measurements based on the on-demand SSB of the SSB-less cell). In one implementation, when an on-demand SSB SCell operation of a SCell is required to performed, it means that an associated on-demand SSB configuration of the SCell is activated such that the UE may use one or more on-demand SSBs broadcasted based on the associated on-demand SSB configuration to perform the on-demand SSB SCell operation. In another implementation, when an on-demand SSB SCell operation of a SCell is not required to perform, it means that an associated on-demand SSB configuration of the SCell is deactivated such that the UE may stop the on-demand SSB SCell operation since the UE may expect that one or more on-demand SSBs are not broadcasted based on the associated on-demand SSB configuration. In one implementation, when a second IE (in an SCell configuration of an SCell) that indicates whether an on-demand SSB SCell operation is required is present or is set to a specific value (e.g., 1 or true), the UE who receives the SCell configuration of the SCell may perform an on-demand SSB SCell operation for the SCell (e.g., based on one or more on-demand SSBs broadcasted based on an activated on-demand SSB configuration of the SCell). An on-demand SSB SCell operation for an SCell may include action(s) of performing Cell search of the SCell, performing time or frequency synchronization to the SCell, performing L1/L3 measurements on the SCell, and/or reporting measurement results based on one or more on-demand SSBs broadcasted based on an activated on-demand SSB configuration of the SCell, but it should not be limited in the disclosure. When a UE is configured or instructed (e.g., via an RRC signaling or an MAC CE) to perform an on-demand SSB SCell operation for an SCell, the UE may follow related on-demand SSB information or configuration (e.g., an on-demand SSB configuration) to perform the on-demand SSB SCell operation, e.g., time or frequency related information of on-demand SSB burst(s), on-demand SSB(s) or SSB burst(s) periodicity and/or time related information (e.g., when on-demand SSB(s) or SSB burst(s) starts being transmitted or broadcast, when on-demand SSB(s) or SSB(s) burst stops being transmitted and broadcasted, or a time period for transmitting on-demand SSB(s) or SSB burst(s), but it should not be limited in the disclosure). The related on-demand SSB information or configuration (e.g., an on-demand SSB configuration) of an SSB-less SCell may be provided via an RRC signaling or an MAC CE. The related on-demand SSB information and configuration may further include information about SSBs to be transmitted in an SSB burst and/or time interval between two SSB bursts. In another implementation, when a second IE (in an SCell configuration of an SCell) that indicates whether the on-demand SSB SCell operation is required is absent or is set to another specific value (e.g., 0 or false), the UE who receives the SCell configuration of the SCell may not perform the on-demand SSB SCell operation for the SCell.

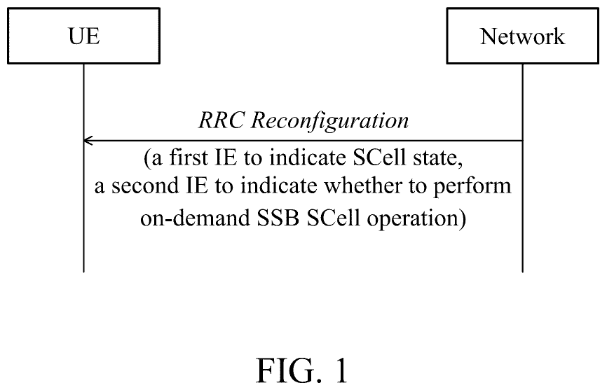

FIG. 1 shows a signaling procedure for adding an SCell by sending an RRC Reconfiguration message with a first IE and a second IE from the NW to the UE according to an implementation of the present disclosure. Upon receiving an RRC signaling including a configuration to add an SCell (e.g., an SSB-less SCell) with an associated SCell configuration which uses the first IE to indicate the state of the SCell is activated (e.g., the first IE is present and is set to a specific value, 1 or true) and uses a second IE to indicate an on-demand SSB SCell operation is required to be performed (e.g., by activating an on-demand SSB configuration of the SCell), the UE may perform the on-demand SSB SCell operation for the SCell and/or apply corresponding SCell activation operation to activate the SCell. The SCell activation operation may include SRS (Sounding Reference Signal) transmission(s) on an associated SCell, CSI (Channel Status Information) reporting for the associated SCell, PDCCH (Physical Downlink Control Channel) monitoring on the associated SCell, PDCCH monitoring for the associated SCell, and/or PUCCH (Physical Uplink Control Channel) transmission(s) on an associated SCell (when the PUCCH configuration of the associated SCell is configured), but it should not be limited in the disclosure. In another implementation, upon receiving a configuration to add an SCell with an associated SCell configuration which uses the first IE to indicate the state of the SCell is activated and uses the second IE to indicate an on-demand SSB SCell operation is required to be performed, and determining that a configured first downlink BWP to be activate (e.g., indicating by firstActiveDownlinkBWP-Id) is not set to a dormant BWP, the UE may perform the on-demand SSB SCell operation for the SCell and/or apply corresponding SCell activation operation to activate the SCell. It should be noted that the UE may need to successfully complete the on-demand SSB SCell operation before applying the normal SCell operation. In case where the UE determines that a configured first downlink BWP to be activated (e.g., indicating by firstActiveDownlinkBWP-Id) is set to the dormant BWP, the UE may not apply corresponding SCell activation operation to activate the SCell. An example of UE (or the MAC entity) operation is shown in Table 1.

```
TABLE 1
The MAC entity shall for each configured SCell:
  1> if an SCell is configured with sCellState set to activated upon SCell configuration,
    or an SCell Activation/Deactivation MAC CE is received activating the SCell:
    2> if the SCell was deactivated prior to receiving this SCell Activation/Deactivation
      MAC CE; or
    2> if the SCell is configured with sCellState set to activated upon SCell
      configuration:
      3> if on-demandSSBSCellOperation set to true:
        4> perform on-demand SSB SCell Operation based on on-demand related
          SSB configuration of the SCell (if configured);
      3> if firstActiveDownlinkBWP-Id is not set to dormant BWP:
        4> activate the SCell according to the timing defined in TS 38.213 for MAC CE
          activation and according to the timing defined in TS 38.133 for direct
          SCell activation; i.e. apply normal SCell operation including:
          5> SRS transmissions on the SCell;
          5> CSI reporting for the SCell;
          5> PDCCH monitoring on the SCell;
          5> PDCCH monitoring for the SCell;
          5> PUCCH transmissions on the SCell, if configured.
      3> else (i.e. firstActiveDownlinkBWP-Id is set to dormant BWP):
        4> stop the bwp-InactivityTimer of this Serving Cell, if running.
      3> activate the DL BWP and UL BWP indicated by firstActiveDownlinkBWP-Id and
        firstActiveUplinkBWP-Id respectively.
```

In one implementation, the upper layer (e.g., the MAC layer of the UE) may inform, instruct, or notify the lower layer (e.g., the PHY layer of the UE) to perform an on-demand SSB SCell operation for an SCell under some condition(s), e.g., when the UE is configured to perform an on-demand SSB SCell operation to the SCell or when receiving a NW signaling (e.g., an RRC signaling, an MAC CE, a DCI, or an on-demand SSB notification command) to instruct the UE to perform the on-demand SSB SCell operation for the SCell. The upper layer (e.g., the MAC layer of the UE) may inform, instruct, or notify the lower layer (e.g., the PHY layer of the UE) to perform the on-demand SSB SCell operation for the SCell by providing its SCell ID (e.g., SCellIndex) and/or the associated on-demand SSB related information/configuration(s). When the UE receives the on-demand SSB notification command for the SSB-less SCell, the UE may expect the on-demand SSB(s) or SSB burst(s) to start being transmitted or broadcasted and the on-demand SSB SCell operation may be required to be performed for at least time or frequency synchronization and L1/L3 measurement reporting (e.g., the CSI reporting). In one implementation, the UE may only perform the on-demand SSB SCell operation for the SCell (e.g., the SSB-less Cell) in the RRC_CONNECTED state. In another implementation, the lower layer (e.g., the PHY layer of a UE) may inform or notify the upper layer (e.g., the MAC layer of the UE or the RRC layer of the UE) that the on-demand SSB SCell operation for the SCell is successfully completed or not successfully completed. The lower layer (e.g., the PHY layer of the UE) may inform or notify the upper layer (e.g., the MAC layer of the UE or the RRC layer of the UE) that the on-demand SSB SCell operation for the SCell is successfully completed by providing the associated SCell ID (e.g., SCellIndex). The lower layer (e.g., the PHY layer of the UE) may inform or notify the upper layer (e.g., the MAC layer of the UE or the RRC layer of the UE) that the on-demand SSB SCell operation for the SCell is not successfully completed by providing the associated SCell ID. Accordingly, the upper layer (e.g., the MAC layer of the UE or the RRC layer of the UE) may inform the NW that the on-demand SSB SCell operation for the SCell is successfully completed and/or not successfully completed. In another implementation, when the NW receives a CSI reporting which is measured based on the on-demand SSB(s) or SSB burst(s), the NW may be considered that the on-demand SSB SCell operation for an associated SCell is successfully complete.

In one implementation, upon receiving a configuration to add an SCell (e.g., an SSB-less SCell) with the associated SCell configuration which uses the first IE to indicate the state of the SCell is deactivated (e.g., the first IE is not present) and uses the second IE to indicate the on-demand SSB SCell operation is required to be performed (e.g., by activating an on-demand SSB configuration of the SCell), the UE may perform the on-demand SSB SCell operation for the SCell but may not apply a corresponding SCell activation operation to activate the SCell. The purpose of performing the on-demand SSB SCell operation for the deactivated SCell may be to reduce delay of the SCell activation operation for the SSB-less SCell since the time or frequency synchronization and/or the L1 or L3 measurements to the SSB-less SCell is done before applying the corresponding SCell activation operation. An example of the UE (or the MAC entity) operation is shown in Table 2. An on-demand SSB notification command may indicate that an associated on-demand SSB configuration of a SCell is activated or deactivated. When an associated on-demand SSB configuration of a SCell is activated, the UE may perform an on-demand SSB SCell operation of the SCell based on one or more on-demand SSBs which are broadcasted based on the activated on-demand SSB configuration. When an associated on-demand SSB configuration of a SCell is deactivated, the UE may stop an on-going on-demand SSB SCell operation of the SCell.

```
TABLE 2
The MAC entity shall for each configured SCell:
  1> if the SCell is deactivated:
    2> not transmit SRS on the SCell;
    2> not report CSI for the SCell;
    2> not transmit on UL-SCH on the SCell;
    2> not transmit on RACH on the SCell;
    2> not monitor the PDCCH on the SCell;
    2> not monitor the PDCCH for the SCell;
    2> not transmit PUCCH on the SCell.
  1> if the SCell is configured with on-demandSSBSCellOperation set to true or an on-
    demand SSB notification command is received:
    2> perform on-demand SSB SCell Operation based on on-demand SSB
      configuration of the SCell (if configured);
```

In one implementation, the UE may inform the NW whether the on-demand SSB SCell operation for the SCell (e.g., an SSB-less SCell) is successfully completed. For example, the UE may inform the NW that the on-demand SSB SCell operation for the SCell with SCell ID #1 is successfully completed via an RRS signaling, an MAC CE, an UCI (Uplink Control Information), or an UL signaling (e.g., a CSI reporting). For another example, the UE may inform the NW that the on-demand SSB SCell operation for the SCell with SCell ID #2 is not successfully completed. In this case, when the UE receives the MAC CE (e.g., an SCell Activation/Deactivation MAC CE as introduced in TS 38.321 of Release 18) to activate the SCell with SCell ID #2, the UE may need to perform the on-demand SSB SCell operation for the SCell again, and then apply a corresponding SCell activation operation to activate the SCell once the on-demand SSB SCell operation for the SCell is successfully completed. When the NW receives the information from the UE to indicate whether the on-demand SSB SCell operation for the SCell is successfully completed, the NW may take corresponding actions accordingly. For example, the NW may only be allowed to transmit an MAC CE (e.g., an SCell Activation/Deactivation MAC CE as introduced in TS 38.321 of Release 18) to activate the SSB-less SCell when the on-demand SSB SCell operation for the SSB-less SCell is successfully completed. For another example, when the NW receives information of the on-demand SSB SCell operation for the SSB-less SCell from the UE is not successfully completed, the NW may instruct the UE to perform another on-demand SSB SCell operation for the SSB-less SCell via an RRC signaling, an MAC CE, a DCI, or an on-demand SSB notification command. In some implementation, the on-demand SSB notification command may be a modified SCell Activation/Deactivation MAC CE. The original design of SCell Activation/Deactivation MAC CE is as introduced in TS 38.321 of Release 18. In one implementation, when the UE receives the SCell Activation/Deactivation MAC CE to change the state of the SCell from activated to deactivated, the UE (or the MAC entity of the UE) may stop any on-going on-demand SSB SCell operation for the SCell.

In one implementation, upon receiving the configuration to add an SCell (e.g., an SSB-less SCell) with the associated SCell configuration which uses the first IE to indicate the state of the SCell is activated (e.g., the first IE is present and is set to a specific value, 1 or true) and uses the second IE to indicate the on-demand SSB SCell operation is not required to be performed (e.g., by deactivating an on-demand SSB configuration of the SCell), the UE may not perform the on-demand SSB SCell operation for the SCell but may apply the corresponding SCell activation operation to activate the SCell. In another implementation, the NW is not allowed to provide the configuration to add an SSB-less SCell with the associated SCell configuration which uses the first IE to indicate the state of the SCell is activated (e.g., the first IE is present and is set to a specific value, 1 or true) and uses the second IE to indicate the on-demand SSB SCell operation is not required to be performed. In another implementation, upon receiving the configuration to add the SCell (e.g., an SSB-less SCell) with the associated SCell configuration which uses the first IE to indicate the state of the SCell is activated (e.g., the first IE is present and is set to a specific value, 1 or true) and uses the second IE to indicate the on-demand SSB SCell operation is not required to be performed, the UE may report the failure of SCell activation (e.g., via a failure information message, an MAC CE, or a DCI).

In one implementation, upon receiving the configuration to add the SCell (e.g., an SSB-less SCell) with the associated SCell configuration which uses the first IE to indicate the state of the SCell is deactivated (e.g., the first IE is not present) and uses the second IE to indicate the on-demand SSB SCell operation is not required to be performed (e.g., by deactivating an on-demand SSB configuration of the SCell), the UE may not perform the on-demand SSB SCell operation for the SCell and may not apply the corresponding SCell activation operation to activate the SCell.

In some implementations, the upper layer (e.g., the MAC layer of the UE) may inform, instruct, or notify the lower layer (e.g., the PHY layer of the UE) not to perform the time or frequency synchronization for the SCell (or its associated frequency or carrier) under some condition(s), e.g., the SCell is configured, informed, or indicated as an SSB-less SCell or the activated SSB-less SCell is de-activated or released by the NW command (e.g., an RRC signaling or an MCE CE), but it should not be limited in the disclosure. In some implementations, the upper layer (e.g., the MAC layer of the UE) may inform, instruct, or notify lower layer (e.g., the PHY layer of the UE) information of the on-demand SSB information or configuration of the SSB-less cell under some condition(s), e.g., the on-demand SSB information or configuration is received via an RRC signaling or an MAC CE, but it should not be limited in the disclosure.

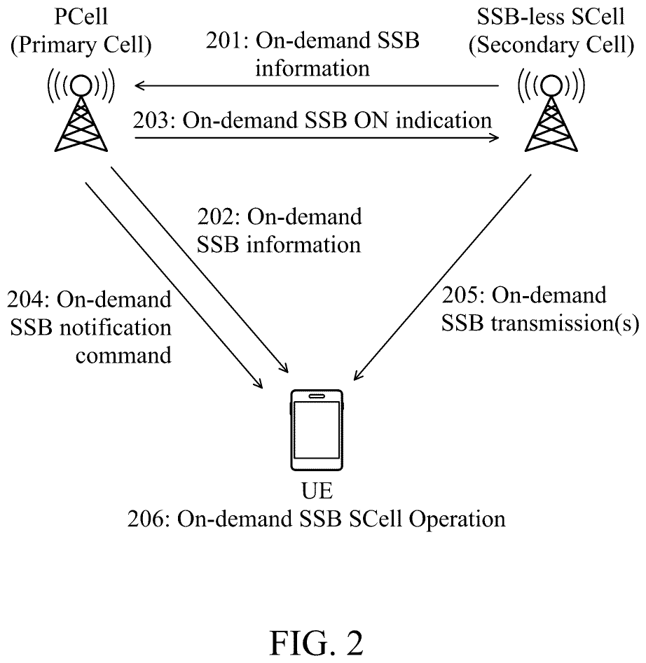

FIG. 2 shows an on-demand SSB SCell operation triggered by an on-demand SSB notification command according to an implementation of the present disclosure. It should be noted that one or more steps in FIG. 2 may or may not be performed. For example, when the PCell already knows the pre-defined on-demand SSB information or configuration of the SSB-less SCell, step 201 of FIG. 2 may not be required. Also, the order of the steps of FIG. 2 may not be mandatory. For example, the PCell may send an on-demand SSB notification command before sending an on-demand SSB ON indication to a (target) SSB-less SCell.

Step 201: an SSB-less SCell (or its associated base station) may provide an on-demand SSB information or configuration to a cell (e.g., a cell which may serve an UE as a Primary cell). The cell (e.g., the Cell which may serve the UE as a Primary cell) may send a request to the SSB-less SCell for its on-demand SSB information or configuration. The SSB-less SCell may provide latest or updated on-demand SSB information or configuration to the cell (e.g., the cell which may serve the UE as a Primary cell), if required.

Step 202: the PCell of the UE may configure the SSB-less cell as an SCell for the purpose of CA (e.g., to combine multiple frequency blocks, or carriers, to serve the UE with the highest quality of experience) via a RRC signaling. The initial state of the SSB-less cell may be “activated” or “deactivated”, which is configured by the PCell (or its associated base station). In the same RRC signaling or in different RRC signaling, the PCell (or its associated base station) may also provide corresponding on-demand SSB information or configuration of the SSB-less cell which is configured as an SCell. The on-demand SSB information or configuration of the SSB-less cell may include time or frequency related information of on-demand SSB burst(s) (e.g., the SSBs to be transmitted in an SSB burst and/or time interval between two SSB bursts), on-demand SSB(s)/SSB burst(s) periodicity and/or time related information (e.g., when on-demand SSB(s)/SSB burst(s) starts being transmitted or broadcasted, when on-demand SSB(s)/SSB burst(s) stops being transmitted or broadcasted, or a time period for transmitting on-demand SSB(s)/SSB burst(s)), but it should not be limited in the disclosure. In another implementation, the on-demand SSB information or configuration of the SSB-less cell may be provided in an on-demand SSB notification command (e.g., an MCE CE). In another implementation, some parts of the on-demand SSB information or configuration of the SSB-less cell may be provided via an RRC signaling and rest parts of the on-demand SSB information or configuration of the SSB-less cell may be provided via an MAC CE. For example, the time or frequency related information of on-demand SSB burst(s) may be provided via an RRC signaling and the time related information may be provided via an MAC CE. In another implementation, all on-demand SSB information or configuration of the SSB-less cell may be provided via an RRC signaling and a PCell (or its associated base station) may update or change certain the on-demand SSB information or configuration of the SSB-less cell via an MAC CE or another RRC signaling.

Step 203: the PCell (or its associated base station) of the UE may determine that the UE needs to perform the on-demand SSB SCell operation for the SCell (e.g., the SSB-less SCell). Then, the PCell may send an on-demand SSB ON indication to the SCell. In one implementation, the PCell (or its associated base station) of the UE may send an on-demand SSB OFF indication to the SCell (e.g., the SSB-less SCell) when the on-demand SSB(s)/SSB burst(s) transmissions are not required.

Step 204: the PCell (or its associated base station) of the UE may transmit an on-demand SSB notification command to the UE. The on-demand SSB notification command may indicate the target SSB-less Cell, e.g., by using an SCell ID (e.g., SCellIndex). The on-demand SSB notification command may also include some or all on-demand SSB related information or configuration. When the UE receives the on-demand SSB notification command (e.g. to activate the received or configured on-demand SSB information or configuration), the UE may expect that the on-demand SSB(s) of the SSB-less Cell will be transmitted or be broadcasted based on the received or configured on-demand SSB information or configuration. In one implementation, the on-demand SSB notification command (e.g. to activate the received or configured on-demand SSB information or configuration) may instruct the UE to perform the on-demand SSB SCell operation for the target Cell. That is, the UE may expect that the on-demand SSB(s) of the SSB-less Cell will be transmitted or broadcasted based on the received or configured on-demand SSB configuration or information. In another implementation, the on-demand SSB notification command (e.g. to deactivate the received or configured on-demand SSB information or configuration) may instruct the UE to stop or suspend performing the on-demand SSB SCell operation for the target Cell. That is, the UE may expect that the on-demand SSB(s) of the SSB-less Cell will not be transmitted or broadcasted. For example, when the target cell is configured to be deactivated or released, the PCell (or its associated base station) of the UE may transmit the on-demand SSB SCell notification command to instruct the UE to stop the on-going on-demand SSB SCell operation for the target Cell. In one implementation, the value of a specific field in the on-demand SSB notification command set to 1 indicates that the UE needs to perform the on-demand SSB SCell operation for the target Cell. The value of a specific field in the on-demand SSB notification command set to 0 indicates that the UE does not need to perform (or needs to stop or suspend) the on-demand SSB SCell operation for the target Cell.

Step 205: the SSB-less cell may start transmitting or broadcasting the on-demand SSB(s) (or SSB burst(s)). For example, when receiving an on-demand SSB ON indication from another cell, the SSB-less cell may start transmitting or broadcasting the on-demand SSB(s) (or SSB burst(s)). The SSB-less cell may transmit or broadcast the on-demand SSB(s) or SSB burst(s) based on pre-given on-demand SSB configuration or information. In another implementation, when the SSB-less cell stops transmitting or broadcasting the on-demand SSB(s), the SSB-less cell may start transmitting or broadcasting the regular SSB(s) (or SSB burst(s)) (e.g., based on the SSB configuration or information provided in the system information). It should be noted that the on-demand SSB(s) or SSB burst(s) and the regular SSB(s) or SSB burst(s) may be configured with different transmitting or broadcasting periodicities. For example, the on-demand SSB(s) or SSB burst(s) may be configured with a shorter periodicity. Instead, the regular SSB(s) or SSB burst(s) may be configured with a longer periodicity. In one implementation, the SSB-less cell may stop transmitting or broadcasting the on-demand SSB(s) or SSB burst(s) when receiving an on-demand SSB OFF indication from another cell.

Step 206: after receiving the on-demand SSB notification command from the PCell (or its associated base station) (e.g., to activate the received or configured on-demand SSB information or configuration of a target SSB-less SCell), the UE may perform the on-demand SSB SCell operation for the target SSB-less SCell. For example, the UE may acquire the on-demand SSB of the SSB-less cell for the time or frequency synchronization to the target SSB-less cell and/or to perform the L1 or L3 measurements based on the on-demand SSB of the target SSB-less cell. In one implementation, when the state of the target SSB-less SCell is activated, the UE may perform the on-demand SSB SCell operation for the target SSB-less SCell based on the pre-given on-demand SSB configuration or information (e.g., from an RRC signaling or an MAC CE). In one implementation, when the state of the target SSB-less SCell is activated and the on-demand SSB configuration or information (e.g., from a RRC signaling or an MAC CE) is not received, configured, or valid, the UE may perform the on-demand SSB SCell operation for the target SSB-less SCell based on the regular SSB transmission (e.g., the SSB configuration or information provided in the system information). In one implementation, the value of a specific field in the on-demand SSB notification command set to 1 indicates that the UE needs to perform the on-demand SSB SCell operation for the target SSB-less SCell. The value of a specific field in the on-demand SSB notification command set to 0 indicates that the UE does not need to perform (or needs to stop or suspend) the on-demand SSB SCell operation for the target SSB-less SCell.

### On-Demand SSB SCell Operation Triggering

In one implementation, when the UE receives the on-demand SSB notification command (e.g., an RRC signaling or an MAC CE to activate an association on-demand SSB configuration) for a configured SCell, the UE may perform the on-demand SSB SCell operation to the configured SCell. The on-demand SSB SCell operation for the SCell may include action(s) of performing a Cell search of the SCell, performing the time or frequency synchronization to the SCell, and/or performing the L1 or L3 measurements on the SCell, but it should not be limited in the disclosure. In one implementation, when the UE receives the on-demand SSB notification command (e.g., an RRC signaling or an MAC CE to activate an association on-demand SSB configuration) for the configured SCell in the activated state, the UE may perform the on-demand SSB SCell operation to the configured SCell to at least remain the time or frequency synchronization and/or report the CSI to the NW for reference. In this case, the UE may only report the on-demand SSB(s) or SSB burst(s)-related CSI when the on-demand SSB(s) or SSB burst(s) are still being transmitted or broadcasted. In cast where the on-demand SSB(s) or SSB burst(s) are not transmitted or broadcasted, the UE may report the CSI when the regular SSB(s) or SSB burst(s) (or the always-on SSB(s) or SSB burst(s)) are transmitted or broadcasted by the SCell. In one implementation, when the UE receives the on-demand SSB notification command (e.g., an RRC signaling or an MAC CE to activate an association on-demand SSB configuration) for the configured SCell in the deactivated state, the UE may perform the on-demand SSB SCell operation to the configured SCell for fast SCell activation. In this case, the UE may only report the on-demand SSB(s) or SSB burst(s)-related CSI when the on-demand SSB(s) or SSB burst(s) are still being transmitted or broadcasted.

In one implementation, when the UE receives the on-demand SSB notification command (e.g., an MAC CE or an RRC signaling to activate an association on-demand SSB configuration) for the configured SCell, the UE may perform the on-demand SSB SCell operation to the configured SCell after a time gap G1. For example, when the UE receives the on-demand SSB notification command (e.g., an MAC CE) at time T1, the UE may expect that the on-demand SSB(s) or SSB burst(s) will be transmitted or broadcasted at time T1+G1. The time unit of T1 and G1 may be a frame, a slot, a subframe, a symbol, or a millisecond (ms). The value of G1 may be provided by an RRC signaling or an on-demand SSB notification command (e.g., an MAC CE). The value of G1 may be configured, predetermined, or predefined. In one implementation, the upper layer of the UE (e.g., the MAC layer) may provide information about G1 and/or information of the on-demand SSB notification command to the lower layer of the UE (e.g., the PHY layer). According to the information, the lower layer of the UE may know when the UE starts performing the on-demand SSB SCell operation for the target SCell or when the UE stops or suspends the (on-going) on-demand SSB SCell operation for the target SCell.

In one implementation, when the UE receives the on-demand SSB notification command (e.g., an MAC CE or an RRC signaling to activate an association on-demand SSB configuration) for the configured SCell, the UE may perform the on-demand SSB SCell operation to the configured SCell after a time gap G1 until the NW sends a second command to inform that the on-demand SSB(s) or SSB burst(s) will not be transmitted or broadcasted anymore. The second command may be an RRC signaling or an on-demand SSB notification command (e.g., an MAC CE). In one implementation, the on-demand SSB notification command may indicate whether the on-demand SSB SCell operation for the SCell (e.g., the SSB-less SCell) shall be performed or shall be stopped or suspended (e.g., by activating or deactivating an associated on-demand SSB configuration of the SCell). In one implementation, when the UE receives the second command associated with the SCell, the UE may stop any on-going on-demand SSB SCell operation for the SCell immediately. In another implementation, when the UE receives the second command associated with the SCell, the UE may stop or suspend any on-going on-demand SSB SCell operation for the SCell after a time gap G2. For example, when the UE receives the second command at time T2, the UE may expect that the on-demand SSB(s) or SSB burst(s) will not be transmitted or broadcasted at time T2+G2. The time unit of T2 and G2 may be a frame, a slot, a subframe, a symbol, or a millisecond. The value of G2 may be provided by an RRC signaling or an on-demand SSB notification command (e.g., an MAC CE). The value of G2 may be configured or predefined. In one implementation, the upper layer of the UE (e.g., the MAC layer) may provide the information about G2, the information of the on-demand SSB notification command, and/or the information of the second command to the lower layer of the UE (e.g., the PHY layer). According to the information, the lower layer of the UE may know when the UE starts performing the on-demand SSB SCell operation for the target SCell or when the UE stops or suspends the (on-going) on-demand SSB SCell operation for the target SCell.

In one implementation, when the UE receives the on-demand SSB notification command (e.g., an MAC CE or an RRC signaling to activate an association on-demand SSB configuration) for the configured SCell, the UE may perform the on-demand SSB SCell operation to the configured SCell after a time gap G3 and stop any on-going on-demand SSB SCell operation for the SCell after a time gap G4. For example, when the UE receives the on-demand SSB notification command (e.g., an MAC CE) at time T3, the UE may expect that on-demand SSB(s) or SSB burst(s) will be transmitted or broadcasted at time T3+G3. The UE may expect that the on-demand SSB(s) or SSB burst(s) will not be transmitted or broadcasted at time T3+G4. The time unit of T3, G3, and G4 may be a frame, a slot, a subframe, a symbol, or a millisecond. The values of G3 and G4 may be provided by an RRC signaling or an on-demand SSB notification command (e.g., an MAC CE). The values of G3 and G4 may be configured or predefined. In one implementation, the upper layer of the UE (e.g., the MAC layer) may provide the information about G3/G4 and/or the information of the on-demand SSB notification command to the lower layer of the UE (e.g., the PHY layer). According to the information, the lower layer of the UE may know when the UE starts performing the on-demand SSB SCell operation for the target SCell or when the UE stops or suspends the (on-going) on-demand SSB SCell operation for the target SCell. For example, when the UE receives the on-demand SSB notification command at time T3, the UE may expect that the on-demand SSB(s) or SSB burst(s) will be transmitted or broadcasted at time T3+G3. The UE may expect that the on-demand SSB(s) or SSB burst(s) will not be transmitted or broadcasted at time T3+G3+G4.

In one implementation, when the UE receives the on-demand SSB notification command (e.g., an MAC CE or an RRC signaling to activate an association on-demand SSB configuration) for the configured SCell, the UE may perform the on-demand SSB SCell operation to the configured SCell after a time gap G3 and stop any on-going on-demand SSB SCell operation for the SCell after a time gap G4. But when the UE is informed or configured to perform the on-demand SSB SCell operation based on the regular SSB or SSB burst(s), the UE may keep performing the on-demand SSB SCell operation based on the regular SSB or SSB burst(s). In one implementation, the UE may be informed or configured via an RRC signaling or an on-demand SSB notification command (e.g., an MAC CE) to perform the on-demand SSB SCell operation based on the regular SSB or SSB burst(s) once the on-demand SSB(s) or SSB burst(s) are not transmitted or broadcasted (e.g., based on the on-demand SSB(s) or SSB burst(s) transmission or broadcast period or the NW notification).

In one implementation, the on-demand SSB notification command may be an MAC CE (namely an On-Demand SSB Notification MAC CE), which is identified by an MAC subheader with a specific logical channel identifier (LCID) or an extended LCID (eLCID). It should be noted that the LCID or the eLCID of the On-Demand SSB Notification MAC CE is different from the LCID of the SCell Activation/Deactivation MAC CE (as introduced in TS 38.321 of Release 18). In one implementation, the On-Demand SSB Notification MAC CE may at least consist of one or more C-fields and one or more R fields.

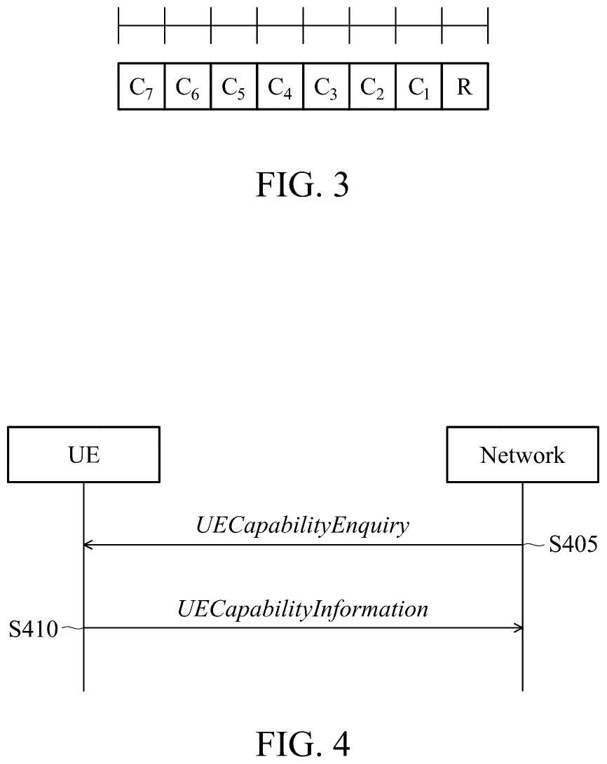

FIG. 3 shows the On-Demand SSB Notification MAC CE of one octet according to an implementation of the present disclosure. It should be noted that other field(s) related to the on-demand SSB information, e.g., the time or frequency-related information of the on-demand SSB burst(s) (e.g., the SSBs to be transmitted in an SSB burst and/or time interval between two SSB bursts), the on-demand SSB periodicity and/or time related information (e.g., when the on-demand SSB starts being transmitted, when the on-demand SSB stops being transmitted, or the time period for transmitting the on-demand SSB) may also be included in the On-Demand SSB Notification MAC CE. In addition, the R field is used as a reserved bit.

In one implementation, Cᵢ field in the On-Demand SSB Notification MAC CE indicates an on-demand SSB state of the SCell with SCellIndex i. When the Cᵢ field is set to a specific value (e.g., 1), it means that the on-demand SSB(s) or SSB burst(s) of the Cell with SCellIndex i is (or will be) transmitted or broadcasted (or the associated on-demand SSB configuration is activated). When the Cᵢ field is set to a specific value (e.g., 0), it means that the on-demand SSB(s) or SSB burst(s) of the Cell with SCellIndex i is not (or will not be) transmitted or broadcasted (or the associated on-demand SSB configuration is deactivated). The timing to transmit or broadcast the on-demand SSB(s) or SSB burst(s) of the Cell may depend on different designs as disclosed in the above-mentioned implementations. In another implementation, there are an On-Demand SSB Notification MAC CE of one octet identified by an MAC subheader with a first LCID (or eLCID) and an On-Demand SSB Notification MAC CE of four octets identified by an MAC subheader with a second LCID (or eLCID). The On-Demand SSB Notification MAC CE of one octet may at least consist of 7 Cᵢ fields and 1 R field. The On-Demand SSB Notification MAC CE of four octets may at least consist of 31 Cᵢ fields and 1 R field.

In another implementation, the Cᵢ field in the On-Demand SSB Notification MAC CE indicates the on-demand SSB SCell operation triggering of an SCell with SCellIndex i. When the Cᵢ field is set to a specific value (e.g., 1), it means that the UE needs to perform the on-demand SSB SCell operation for the cell with SCellIndex i. When the Cᵢ field is set to a specific value (e.g., 0), it means that the UE does not need to perform (or needs to stop or suspend) the on-demand SSB SCell operation for the cell with SCellIndex i.

In one implementation, the Cᵢ field in the On-Demand SSB Notification MAC CE indicates the on-demand SSB state of the SCell i, wherein i is the ascending order of the SCell ID among the SCell(s) configured or informed as SSB-less SCell(s). When the Cᵢ field is set to a specific value (e.g., 1), it means that the on-demand SSB(s) or SSB burst(s) of the SCell i is (or will be) transmitted or broadcasted (or the associated on-demand SSB configuration is activated). When the Cᵢ field is set to a specific value (e.g., 0), it means that the on-demand SSB(s) or SSB burst(s) of the Cell i is not (or will not be) transmitted or broadcasted (or the associated on-demand SSB configuration is deactivated). The timing to transmit or broadcast the on-demand SSB(s) or SSB burst(s) of the cell may depend on different designs as disclosed in the above-mentioned implementations.

In another implementation, the Cᵢ field in the On-Demand SSB Notification MAC CE indicates the on-demand SSB SCell operation triggering of the SCell i, wherein i is the ascending order of the SCell ID among the SCell(s) configured or informed as SSB-less SCell(s). When the Cᵢ field is set to a specific value (e.g., 1), it means that the UE needs to perform the on-demand SSB SCell operation for the cell with SCellIndex i. When the Cᵢ field is set to a specific value (e.g., 0), it means that the UE does not need to perform (or need to stop or suspend) the on-demand SSB SCell operation for the cell with SCellIndex i.

In one implementation, the SCell Activation/Deactivation MAC CE (as introduced in TS 38.321 of Release 18) may be modified to indicate the on-demand SSB(s) or SSB burst(s) state of the SCell with SCellIndex i by using the R filed. When the R field is set to a specific value (e.g., 0), the Cᵢ field in the SCell Activation/Deactivation MAC CE indicates the activation or deactivation state of the SCell with SCellIndex i. When the Cᵢ field is set to a specific value (e.g., 1), it means that the cell with SCellIndex i may be activated. When the Cᵢ field is set to a specific value (e.g., 0), it means that the cell with SCellIndex i may be deactivated. When the R field is set to a specific value (e.g., 0), the Cᵢ field in the SCell Activation/Deactivation MAC CE indicates the on-demand SSB state of the SCell with SCellIndex i. When the Cᵢ field is set to a specific value (e.g., 1), it means that on-demand SSB(s) or SSB burst(s) of the cell with SCellIndex i is (or will be) transmitted or broadcasted (or the associated on-demand SSB configuration is activated). When the Cᵢ field is set to a specific value (e.g., 0), it means that the on-demand SSB(s) or SSB burst(s) of the cell with SCellIndex i is not (or will not be) transmitted or broadcasted (or the associated on-demand SSB configuration is deactivated).

In another implementation, the SCell Activation/Deactivation MAC CE (as introduced in TS 38.321 of Release 18) may be modified to indicate the on-demand SSB(s) or SSB burst(s) state of the SCell with SCellIndex i by using the R filed. When the R field is set to a specific value (e.g., 0), the Cᵢ field in the SCell Activation/Deactivation MAC CE indicates the activation or deactivation state of the SCell with SCellIndex i. When the Cᵢ field is set to a specific value (e.g., 1), it means that the cell with SCellIndex i may be activated. When the Cᵢ field is set to a specific value (e.g., 0), it means that the cell with SCellIndex i may be deactivated. When the R field is set to a specific value (e.g., 0), the Cᵢ field in the SCell Activation/Deactivation MAC CE indicates the on-demand SSB SCell operation triggering of the SCell with SCellIndex i. When the Cᵢ field is set to a specific value (e.g., 1), it means that the UE needs to perform the on-demand SSB SCell operation for the cell with SCellIndex i. When the Cᵢ field is set to a specific value (e.g., 0), it means that the UE does not need to perform (or needs to stop or suspend) the on-demand SSB SCell operation for the cell with SCellIndex i.

In one implementation, based on the instruction of the On-Demand SSB Notification MAC CE or the SCell Activation/Deactivation MAC CE (or information included in the On-Demand SSB Notification MAC CE or the SCell Activation/Deactivation MAC CE), the UE determines whether to perform the on-demand SSB SCell operation for the SCell, or stops or suspends the on-demand SSB SCell operation for the SCell. For example, when the instruction of the On-Demand SSB Notification MAC CE or the SCell Activation/Deactivation MAC CE (or information included in the On-Demand SSB Notification MAC CE or the SCell Activation/Deactivation MAC CE) indicates that the on-demand SSB(s) or SSB burst(s) of the SCell is transmitted or broadcasted (or will be transmitted or broadcasted, or the associated on-demand SSB configuration is activated), the UE may perform the on-demand SSB SCell operation for the SCell. For another example, when the instruction of the On-Demand SSB Notification MAC CE or the SCell Activation/Deactivation MAC CE (or information included in the On-Demand SSB Notification MAC CE or the SCell Activation/Deactivation MAC CE) indicates that the on-demand SSB(s) or SSB burst(s) of the SCell is not transmitted or broadcasted (or will not be transmitted or broadcasted, or the associated on-demand SSB configuration is deactivated), the UE may stop or suspend the on-demand SSB SCell operation for the SCell.

In one implementation, the NW may configure a deactivation timer (e.g., sCellDeactivationTimer) for each configured SCell, except an SCell configured PUCCH. When the deactivation timer expires, the associated SCell may be considered or determined to be deactivated. To avoid the SCell transitioning to the deactivated state, the UE may restart an associated deactivation timer upon the on-demand SSB SCell operation is on-going. In one implementation, when the deactivation timer of the SSB-less SCell is configured, the SSB-less SCell state is activated, and the on-demand SSB SCell operation for the SCell is on-going (or the On-Demand SSB Notification MAC CE or the SCell Activation/Deactivation MAC CE triggers the on-demand SSB SCell operation for the SCell), the UE (or the MAC layer of the UE) may restart the associated deactivation timer. An example of the UE (or the MAC entity) operation is shown in Table 3.

```
TABLE 3
The MAC entity shall for each configured SCell:
  1> if PDCCH on the activated SCell indicates an uplink grant or downlink assignment;
    or
  1> if PDCCH on the Serving Cell scheduling the activated SCell indicates an uplink grant
    or a downlink assignment for the activated SCell; or
  1> if an MAC PDU is transmitted in a configured uplink grant and LBT failure indication
    is not received from lower layers; or
  1> if an MAC PDU is received in a configured downlink assignment; or
  1> if an on-demand SSB SCell operation for the SCell is triggered:
      2> restart the sCellDeactivationTimer associated with the SCell.
```

An example of the UE (or the MAC entity) operation is shown in Table 4.

```
TABLE 4
The MAC entity shall for each configured SCell:
  1> if PDCCH on the activated SCell indicates an uplink grant or downlink assignment; or
  1> if PDCCH on the Serving Cell scheduling the activated SCell indicates an uplink grant
    or a downlink assignment for the activated SCell; or
  1> if an MAC PDU is transmitted in a configured uplink grant and LBT failure indication
    is not received from lower layers; or
  1> if an MAC PDU is received in a configured downlink assignment; or
  1> if an On-Demand SSB Notification MAC CE (or an SCell Activation/Deactivation
      MAC CE) to trigger an on-demand SSB SCell operation for the SCell is received:
        2> restart the sCellDeactivationTimer associated with the SCell.
```

In one implementation, when the UE receives the SCell Activation/Deactivation MAC CE to activate a deactivated SCell and the deactivated SCell is informed (e.g., by an RRC signaling or an MAC CE) that it is an SSB-less SCell (or considered as an SSB-less SCell), the UE may first perform the on-demand SSB SCell operation (e.g., based on received or configured on-demand SSB information or configuration) and then apply the normal SCell activation operation. In one implementation, the NW may configure the UE to add an SCell (e.g., an SSB-less SCell) by using a first list and an associated SCell configuration of the SCell that includes a third IE to indicate that the SCell is an SSB-less SCell. In another implementation, when the SCell is configured with the on-demand SSB information or configuration (or is associated with the on-demand SSB information or configuration), the UE may consider the SCell as an SSB-less SCell.

### UE Capability

FIG. 4 shows an UE capability reporting procedure according to an implementation of the present disclosure. The network (NW) may initiate this procedure to a UE in the RRC_CONNECTED state when the NW needs UE capability information. That is, the NW may transmit a UE capability enquire message (i.e., UECapabilityEnquiry message) to the UE in S405. Then, the UE may report the requested UE capability message in a UE capability information message (i.e., UECapabilityInformation message) in S410.

In one implementation, the UE may report its capability of supporting the on-demand SSB SCell operation. When the UE supports performing the on-demand SSB SCell operation, it means that the UE may be able to receive an RRC signaling, an MCE CE (e.g., an On-Demand SSB Notification MAC CE or an SCell Activation/Deactivation MAC CE), or a DCI which is used to instruct the UE to perform the on-demand SSB SCell operation for an indicated or target SCell (e.g., an SSB-less SCell). In another implementation, the UE may report its capability of supporting reception of the On-Demand SSB Notification MAC CE or the SCell Activation/Deactivation MAC CE. When the UE supports receiving an On-Demand SSB Notification MAC CE or an SCell Activation/Deactivation MAC CE, it means that the NW may transmit the On-Demand SSB Notification MAC CE or the SCell Activation/Deactivation MAC CE to instruct the UE to trigger the on-demand SSB SCell operation (or activate/deactivate an associated on-demand SSB configuration) for the target SCell (e.g., an SSB-less SCell) and the UE may follow the information including in the On-Demand SSB Notification MAC CE or the SCell Activation/Deactivation MAC CE to perform the on-demand SSB SCell operation for the target SCell based on the received or configured on-demand SSB information or configuration to monitor or detect the on-demand SSB(s) or SSB burst(s) being transmitted or broadcasted.

In one implementation, the UE may report its capability of supporting the on-demand SSB SCell operation for the target SCell (e.g., an SSB-less SCell) when the state of the target SCell is activated. When the UE supports performing the on-demand SSB SCell operation for the target SCell with the state “activated”, the UE may perform the on-demand SSB SCell operation for the target SCell based on the received or configured on-demand SSB information or configuration to monitor or detect the on-demand SSB(s) or SSB burst(s) being transmitted or broadcasted. In case where the UE does not have the valid on-demand SSB information or configuration, the UE may perform the on-demand SSB SCell operation for the target SCell based on the regular SSB(s) or SSB burst(s) when the regular SSB(s)/SSB burst(s) are being transmitted or broadcasted. Whether the UE may perform the on-demand SSB SCell operation for the target SCell based on the regular SSB(s) or SSB burst(s) may depend on the NW instructions or configuration or depend on whether the regular SSB(s) or SSB burst(s) are available. For example, there may be an indication in the system information (e.g., an MIB or an SIB1) indicating that whether the regular SSB(s) or SSB burst(s) are transmitted or broadcasted. When the indication is set to a specific value (e.g., 0), it means that the regular SSB(s) or SSB burst(s) are not transmitted or broadcasted. Instead, when the indication is set to another specific value (e.g., 1), it means that the regular SSB(s) or SSB burst(s) are transmitted or broadcasted.

In one implementation, the UE may report its capability of supporting the on-demand SSB SCell operation for the target SCell (e.g., an SSB-less SCell) when the state of the target SCell is deactivated.

In one implementation, the UE may report its capability of receiving the on-demand SSB notification command to trigger the on-demand SSB SCell operation for the target SCll (e.g., an SSB-less SCell). In one implementation, the UE may report its capability of receiving the On-Demand SSB Notification MAC CE to trigger the on-demand SSB SCell operation for the target SCell (e.g., an SSB-less SCell). In one implementation, the UE may report its capability of receiving a modified SCell Activation/Deactivation MAC CE to trigger the on-demand SSB SCell operation for the target SCell (e.g., an SSB-less SCell).

In one implementation, the UE may report its capability of receiving the on-demand SSB notification command to stop or suspend the on-demand SSB SCell operation for the target SCII (e.g., an SSB-less PCell). In one implementation, the UE may report its capability of receiving the On-Demand SSB Notification MAC CE to stop or suspend the on-demand SSB SCell operation for the target SCell (e.g., an SSB-less SCell). In one implementation, the UE may report its capability of receiving the modified SCell Activation/Deactivation MAC CE to stop or suspend the on-demand SSB SCell operation for the target SCell (e.g., an SSB-less SCell).

In some implementations, the above-mentioned capabilities may be separated for TDD (Time Division Duplex) and FDD (Frequency Division Duplex). For example, the UE may report one capability of supporting the on-demand SSB SCell operation in TDD and report another capability of supporting the on-demand SSB SCell operation in FDD.

In some embodiments, the above-mentioned capabilities may be separated for FR1 (Frequency Range 1) and FR2 (Frequency Range 2). For example, the UE may report one capability of supporting the on-demand SSB SCell operation in FR1 and report another capability of supporting the on-demand SSB SCell operation in FR2.

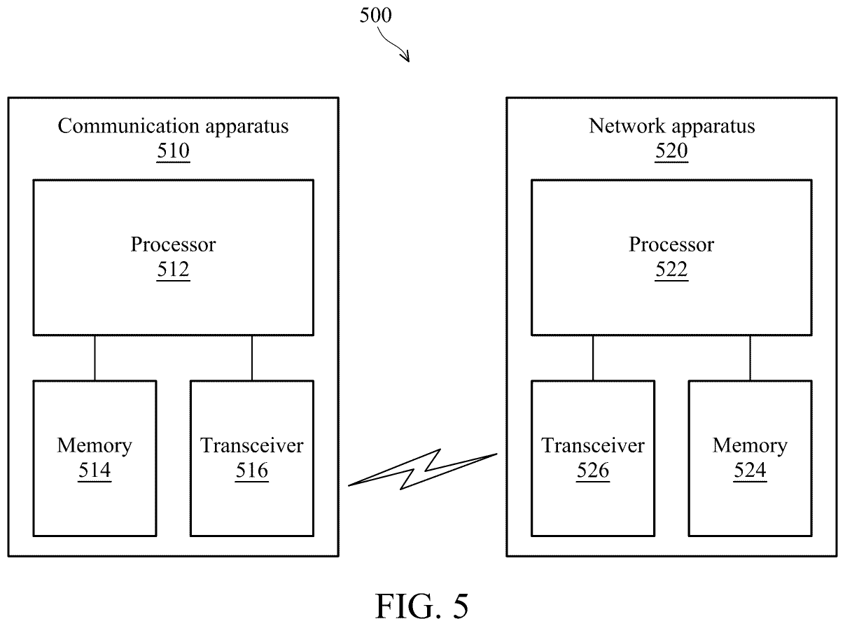

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to network energy saving, including scenarios/schemes described above as well as process 500 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of an electronic apparatus, which may be a network node such as a BS, a small cell, a router or a gateway. For instance, the network apparatus 520 may be implemented in a gNB in a 5G, B5G, 6G, IoT, NB-IoT or IIOT network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including on-demand SSB SCell operations for network energy saving in a UE (e.g., as represented by the communication apparatus 510) and a gNB (e.g., as represented by the network apparatus 520) in accordance with various implementations of the present disclosure.

In some implementations, the communication apparatus 510 may also include a transceiver 516 coupled to the processor 512 and capable of wirelessly transmitting and receiving control and data signals. In some implementations, the transceiver 516 may be capable of wirelessly communicating with different types of gNBs of different RATs. In some implementations, the transceiver 516 may be equipped with a plurality of antenna ports (not shown) such as, for example, four antenna ports. That is, the transceiver 516 may be equipped with multiple transmit antennas and multiple receive antennas for multiple-input multiple-output (MIMO) wireless communications. In some implementations, the network apparatus 520 may also include a transceiver 526 coupled to the processor 522 and capable of wirelessly transmitting and receiving control and data signals. In some implementations, the transceiver 526 may be capable of wirelessly communicating with different types of UEs of different RATs. In some implementations, the transceiver 526 may be equipped with a plurality of antenna ports (not shown) such as, for example, four antenna ports. That is, the transceiver 526 may be equipped with multiple transmit antennas and multiple receive antennas for MIMO wireless communications. Accordingly, the communication apparatus 510 and the network apparatus 520 may wirelessly communicate with each other via the transceiver 516 and transceiver 526, respectively.

In some implementations, the communication apparatus 510 may further include a memory 514 coupled to the processor 512 and capable of being accessed by processor 512 and storing data therein. In some implementations, the network apparatus 520 may further include a memory 524 coupled to the processor 522 and capable of being accessed by the processor 522 and storing data therein. Each of the memory 514 and the memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 514 and the memory 524 may include a type of read-only memory (ROM) such as mask ROM, programmable ROM (PROM), erasable programmable ROM (EPROM) and/or electrically erasable programmable ROM (EEPROM). Alternatively, or additionally, each of the memory 514 and the memory 524 may include a type of non-volatile random-access memory (NVRAM) such as flash memory, solid-state memory, ferroelectric RAM (FeRAM), magnetoresistive RAM (MRAM) and/or phase-change memory.

Each of the communication apparatus 510 and the network apparatus 520 may be a communication entity capable of communicating with each other using various proposed schemes in accordance with the present disclosure. For illustrative purposes and without limitation, a description of operations, functionalities, and capabilities of the communication apparatus 510, implemented in or as a UE (e.g., the UE in FIGS. 1, 2 and 4), and the network apparatus 520, implemented in or as a network (e.g., the network in FIGS. 1 and 4 or the PCell in FIG. 2), is provided below.

According to certain proposed schemes of the present disclosure, the processor 512 of the communication apparatus 510 may receive, via the transceiver 516, a first Medium Access Control (MAC) Control Element (CE) from the network apparatus 520. Specifically, the first MAC CE indicates that an on-demand synchronization signal block (SSB) configuration of a first secondary cell (SCell) is activated, and one or more on-demand SSBs of the first SCell are broadcasted based on the on-demand SSB configuration. Then, the processor 512 may perform an on-demand SSB-based SCell operation based on the one or more on-demand SSBs. Next, the processor 512 may receive, via the transceiver 516, a second MAC CE from the network apparatus 520, wherein the second MAC CE indicates that the on-demand SSB configuration of the first SCell is deactivated. The processor 512 may perform stopping the on-demand SSB-based SCell operation.

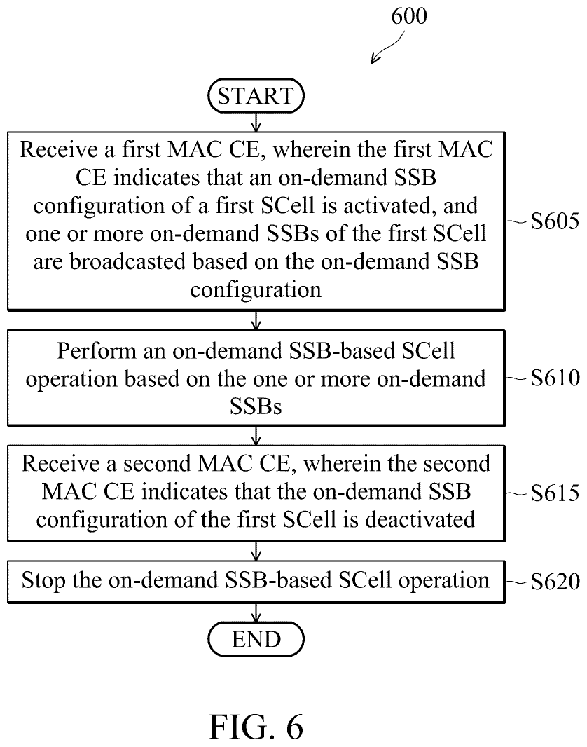

FIG. 6 illustrates an example process 600 in accordance with an implementation of the present disclosure. The process 600 may be an example implementation of above scenarios/schemes, whether partially or completely, with respect to the method for network energy saving. The process 600 may represent an aspect of implementation of features of the communication apparatus 510. The process 600 may include one or more operations, actions, or functions as illustrated by one or more of block S605, S610, S615 and S620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE. Solely for illustrative purposes and without limitation, the process 600 is described below in the context of the communication apparatus 510 as a UE and the network apparatus 520 as a network or a BS. The process 600 may begin at block S605.

In S605, the process 600 may involve the processor 512 of the communication apparatus 510 receiving, via the transceiver 516, a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration. The process 600 may proceed from S605 to S610.

In S610, the process 600 may involve the processor 512 of the communication apparatus 510 performing an on-demand SSB-based SCell operation based on the one or more on-demand SSBs. The process 600 may proceed from S610 to S615.

In S615, the process 600 may involve the processor 512 of the communication apparatus 510 receiving, via the transceiver 516, a second MAC CE, wherein the second MAC CE indicates that the on-demand SSB configuration of the first SCell is deactivated. The process 600 may proceed from S615 to S620.

In step S620, the process 600 may involve the processor 512 of the communication apparatus 510 stopping the on-demand SSB-based SCell operation.

In some implementations, the on-demand SSB configuration is received via a Radio Resource Control (RRC) signaling.

In some implementations, the on-demand SSB configuration includes a periodicity of the one or more on-demand SSBs, which is configured separately from a periodicity of one or more regularly broadcasting SSBs of the first SCell.

In some implementations, the process 600 may involve the processor 512 of the communication apparatus 510 receiving a Radio Resource Control (RRC) signaling to indicate whether the on-demand SSB configuration of the first SCell is activated.

In some implementations, the process 600 may involve the processor 512 of the communication apparatus 510 stopping the on-demand SSB-based SCell operation when receiving a third MAC CE which deactivates the first SCell.

In some implementations, the on-demand SSB-based SCell operation includes at least one of the following actions: performing a cell search procedure of the first SCell; performing a time synchronization procedure of the first SCell; performing a frequency synchronization procedure of the first SCell; performing L1 measurements based on the one or more on-demand SSBs; performing L3 measurements based on the one or more on-demand SSBs and reporting measurement results to a source base station.

In some implementations, the first MAC CE has a plurality of cell index fields, and each different cell index field of the plurality of cell index fields corresponds to a different SCell and indicates whether an on-demand SSB configuration of the different SCell is activated or deactivated.

In some implementations, when the on-demand SSB configuration is activated, the one or more on-demand SSBs of the first SCell are broadcasted at a first time, and the first time is calculated based on a reception time of the first MAC CE and a predefined value of slots.

In some implementations, the process 600 may involve the processor 512 of the communication apparatus 510 reporting a capability of supporting the on-demand SSB-based SCell operation.

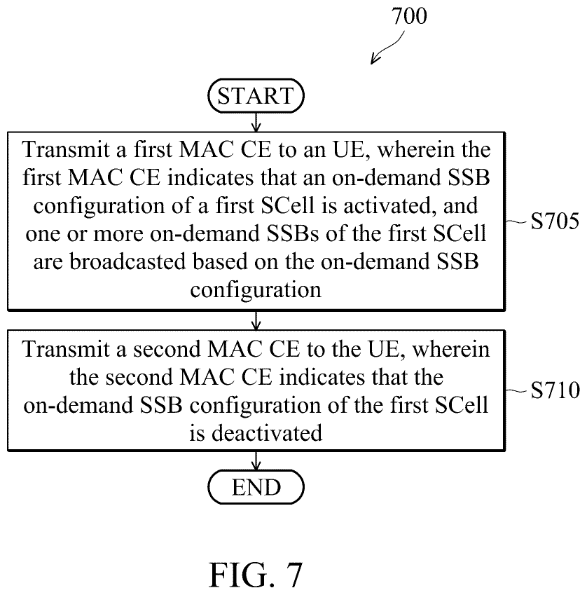

FIG. 7 illustrates an example process 700 in accordance with an implementation of the present disclosure. The process 700 may be an example implementation of above scenarios/schemes, whether partially or completely, with respect to the method for network energy saving. The process 700 may represent an aspect of implementation of features of the network apparatus 520. The process 700 may include one or more operations, actions, or functions as illustrated by one or more of block S705 and S710. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the network apparatus 520 or any suitable network. Solely for illustrative purposes and without limitation, the process 700 is described below in the context of the communication apparatus 510 as a UE and the network apparatus 520 as a network or a BS. The process 700 may begin at block S705.

In S705, the process 700 may involve the processor 522 of the network apparatus 520 transmitting, via the transceiver 526, a first Medium Access Control (MAC) Control Element (CE) to the communication apparatus 510, wherein the first MAC CE indicates that an on-demand synchronization signal block (SSB) configuration of a first secondary cell (SCell) is activated. The process 700 may proceed from S705 to S710.

In S710, the process 700 may involve the processor 522 of the network apparatus 520 transmitting, via the transceiver 526, a second MAC CE to the UE, wherein the second MAC CE indicates that the on-demand SSB configuration of the first SCell is deactivated.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for network energy saving, wherein the method is implemented by a user equipment (UE), and comprises:
receiving a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration;
performing an on-demand SSB-based SCell operation based on the one or more on-demand SSBs;
receiving a second MAC CE, wherein the second MAC CE indicates that the on-demand SSB configuration of the first SCell is deactivated; and
stopping the on-demand SSB-based SCell operation.

2. The method for network energy saving as claimed in claim 1, wherein the on-demand SSB configuration is received via a Radio Resource Control (RRC) signaling.

3. The method for network energy saving as claimed in claim 1, wherein the on-demand SSB configuration includes a periodicity of the one or more on-demand SSBs, which is configured separately from a periodicity of one or more regularly broadcasting SSBs of the first SCell.

4. The method for network energy saving as claimed in claim 1, further comprising:
receiving a Radio Resource Control (RRC) signaling to indicate whether the on-demand SSB configuration of the first SCell is activated.

5. The method for network energy saving as claimed in claim 1, further comprising:
stopping the on-demand SSB-based SCell operation when receiving a third MAC CE which deactivates the first SCell.

6. The method for network energy saving as claimed in claim 1, wherein the on-demand SSB-based SCell operation includes at least one of the following actions:
performing a cell search procedure of the first SCell;
performing a time synchronization procedure of the first SCell;
performing a frequency synchronization procedure of the first SCell;
performing L1 measurements based on the one or more on-demand SSBs;
performing L3 measurements based on the one or more on-demand SSBs; and
reporting measurement results to a source base station.

7. The method for network energy saving as claimed in claim 1, wherein the first MAC CE has a plurality of cell index fields, and each different cell index field of the plurality of cell index fields corresponds to a different SCell and indicates whether an on-demand SSB configuration of the different SCell is activated or deactivated.

8. The method for network energy saving as claimed in claim 1, wherein when the on-demand SSB configuration is activated, the one or more on-demand SSBs of the first SCell are broadcasted at a first time, and the first time is calculated based on a reception time of the first MAC CE and a predefined value of slots.

9. The method for network energy saving as claimed in claim 1, further comprising:
reporting a capability of supporting the on-demand SSB-based SCell operation.

10. An apparatus for network energy saving, comprising:
a transceiver which, during operation, wirelessly communicates with at least one network node; and
a processor communicatively coupled to the transceiver such that, during operation, the processor performs operations comprising:
receiving a first Medium Access Control (MAC) Control Element (CE), wherein the first MAC CE indicates that an on-demand synchronization signal block (SSB) configuration of a first secondary cell (SCell) is activated, and one or more on-demand SSBs of the first SCell are broadcasted based on the on-demand SSB configuration;
performing an on-demand SSB-based SCell operation based on the one or more on-demand SSBs;
receiving a second MAC CE, wherein the second MAC CE indicates that the on-demand SSB configuration of the first SCell is deactivated; and
stopping the on-demand SSB-based SCell operation.

11. The apparatus for network energy saving as claimed in claim 10, wherein the on-demand SSB configuration is received via a Radio Resource Control (RRC) signaling.

12. The apparatus for network energy saving as claimed in claim 10, wherein the on-demand SSB configuration includes a periodicity of the one or more on-demand SSBs, which is configured separately from a periodicity of one or more regularly broadcasting SSBs of the first SCell.

13. The apparatus for network energy saving as claimed in claim 10, wherein the processor further performs operations comprising:
receiving a Radio Resource Control (RRC) signaling to indicate whether the on-demand SSB configuration is activated.

14. The apparatus for network energy saving as claimed in claim 10, wherein the processor further performs operations comprising:
stopping the on-demand SSB-based SCell operation when receiving a third MAC CE which deactivates the first SCell.

15. The apparatus for network energy saving as claimed in claim 10, wherein the on-demand SSB-based SCell operation includes at least one of the following actions:
performing a cell search procedure of the first SCell;
performing a time synchronization procedure of the first SCell;
performing a frequency synchronization procedure of the first SCell;
performing L1 measurements based on the one or more on-demand SSB;
performing L3 measurements based on the one or more on-demand SSBs; and
reporting measurement results to a source base station.

16. The apparatus for network energy saving as claimed in claim 10, wherein the first MAC CE has a plurality of cell index fields, and each different cell index field of the plurality of cell index fields corresponds to a different SCell and indicates whether an on-demand SSB configuration of the different SCell is activated or deactivated.

17. The apparatus for network energy saving as claimed in claim 10, wherein when the on-demand SSB configuration is activated, the one or more on-demand SSBs of the first SCell are broadcasted in a first time, and the first time is calculated based on a reception time of the first MAC CE and a predefined value of slots.

18. The apparatus for network energy saving as claimed in claim 10, wherein the processor further performs operations comprising:
reporting a capability of supporting the on-demand SSB-based SCell operation.

19. A method for network energy saving, wherein the method is implemented by a source base station, and comprises:
transmitting a first Medium Access Control (MAC) Control Element (CE) to a user equipment (UE), wherein the first MAC CE indicates that an on-demand synchronization signal block (SSB) configuration of a first secondary cell (SCell) is activated; and
transmitting a second MAC CE to the UE, wherein the second MAC CE indicates that the on-demand SSB configuration of the first SCell is deactivated.

20. The method for network energy saving as claimed in claim 19, further comprising:
transmitting a Radio Resource Control (RRC) signaling to the UE to indicate whether the on-demand SSB configuration of the first SCell is activated.

21. The method for network energy saving as claimed in claim 19, wherein the first MAC CE has a plurality of cell index fields, and each different cell index field of the plurality of cell index fields corresponds to a different SCell and indicates whether an on-demand SSB configuration of the different SCell is activated or deactivated.
